(19) United States
(12) Patent Application Publication
(10) Pub. No.: US 2024/0013985 A1
(43) Pub. Date: Jan. 11, 2024

(54) SAFETY SWITCH

(71) Applicant: Miba Sinter Austria GmbH, Laakirchen (AT)

(72) Inventor: Manuel POHN, Lenzing (AT)

(21) Appl. No.: 18/346,713

(22) Filed: Jul. 3, 2023

(30) Foreign Application Priority Data
Jul. 5, 2022 (AT) A50492/2022

(51) Int. Cl. H01H 1/02; H01H 39/00; H01H 1/20; H01H 1/06; B33Y 80/00

(52) U.S. Cl. CPC H01H 1/02; H01H 39/004; H01H 1/20; H01H 1/06; B33Y 80/00

(57) ABSTRACT

A safety switch useful for electric motor vehicles comprises a first electrical conductor, a second electrical conductor, a third electrical conductor and an actuator, wherein a gap is formed between the first conductor and the second electrical conductor, which gap can be bridged in an electrically conductive manner with the third electrical conductor by making contact with the first and second electrical conductors, wherein the third electrical conductor is arranged in a rest position from which the third electrical conductor can be brought by the actuator into the position bridging the gap, and wherein either the third electrical conductor consists at least partially of a porous material and/or at least one of the first and/or the second electrical conductor consists at least partially of a porous material and the porous material has a density of at least 80% of the theoretical density of the material.

### CROSS-REFERENCE TO RELATED APPLICATIONS

This application claims priority under 35 U.S.C. § 119(a)-(d) of Austrian Patent Application No. A50492/2022, filed Jul. 5, 2022, which is hereby incorporated by reference in its entirety.

### TECHNICAL FIELD

The field of the present disclosure relates to a safety switch having at least one conductor formed at least partially of a porous material, to a motor vehicle including such a safety switch for dissipating energy from a rechargeable storage element for electrical energy and/or an electric energy generating element, and to a method of closing a circuit using a conductor made of a porous material.

### BACKGROUND

Due to the reorientation of mobility from classic combustion engines to electric motors and the energy storage systems used for this purpose, problems arise with regard to accident management. Extinguishing fires in electric vehicles in particular sometimes poses a problem due to the energy storage devices installed.

To remedy this, safety switches have been described in the state of the art. These are provided to isolate the installed energy storage devices in a motor vehicle in the event of a trip, i.e., in particular in the event of a traffic accident, and to disconnect them from the rest of the on-board electrical system. In addition, such safety switches are used to isolate individual assemblies within the on-board electrical system in the event of a trip, for example to disconnect capacitors from the mains.

Such a breaker is described, for example, in WO 2016/120062 A1. A pyrotechnic safety element is known therefrom, in particular for the automotive sector, comprising a conductor, a pyrotechnic unit with a pyrotechnic propellant, a separating body for severing the conductor and a housing, wherein the conductor is formed by two separate conductor sections which are connected to one another at a connection point and are separated again at the connection point by the separating body in the event of a trip.

So-called make contacts are to be distinguished from breakers. Unlike the breakers, they close a circuit in the event of tripping, thus enabling the targeted discharge of assemblies.

For example, AT 521539 A1 describes a pyrotechnic make contact comprising a housing with a cylindrical recess in which a piston can be moved by a pyrotechnic charge from an initial position to an end position. Two flat conductors are arranged in the housing, which are insulated from each other in the initial position of the piston. In the end position of the piston, they are electrically connected by a connecting element, wherein there is an press fit between the connecting element and the conductors. The ends of the conductors rest on the inside of the recess with their flat side after the release. The connecting element is formed by the piston, which either carries a conductive ring or is conductive itself. By forming the housing from a polymer material, the press fit can be enabled as a result of a deformation of the housing. The housing may be composed of a main part and a closing part, with the conductors guided between these two parts.

DE 10 2019 101 307 B3 describes an electrical make contact, in particular for a motor vehicle line, in particular a motor vehicle power line comprising: a first electrical terminal and a second electrical terminal, a first contact element which is electrically connected to the first terminal, a second contact element which is electrically connected to the second terminal, a connecting element by means of which an electrical connection can be established between the two contact elements, and a drive which causes a relative movement between at least one of the contact elements and the connecting element, the connecting element or the contact elements being formed at least in parts from an electrically conductive material, and the electrically conductive material being porous or pasty. The porous material may be produced in different ways, in particular using a foaming of an expanding agent to produce a porous metal. The expanding agent is introduced into a metal powder and the mixture of metal and expanding agent is treated, in particular heated, whereby the expanding agent outgasses and foams, thus forming the porosity. It is also possible that a metal/salt mixture is formed in a casting process and then the salt is washed out and the remaining metal matrix forms the porous metal. Sintering of a metal powder is also mentioned in this publication as a possibility leading to the porous material, but no further details are given in this publication.

A need remains to improve safety for rescue workers in the event of an accident involving an electric vehicle.

### SUMMARY

A safety switch comprises a first electrical conductor, a second electrical conductor, a third electrical conductor and an actuator, wherein a gap is formed between the first conductor and the second electrical conductor, which gap can be bridged in an electrically conductive manner with the third electrical conductor by making contact with the first and second electrical conductors, wherein the third electrical conductor is arranged in a rest position from which the third electrical conductor can be brought by the actuator into the position bridging the gap, and wherein either the third electrical conductor consists at least partially of a porous material and/or at least one of the first and/or the second electrical conductor consists at least partially of a porous material, in which the porous material has a density of at least 80% of the theoretical density of the material.

In another embodiment, a motor vehicle comprises such a safety switch for dissipating electrical energy from a rechargeable storage element for electrical energy and/or an electrical energy generating element of the motor vehicle.

In still another embodiment, a method for closing a circuit comprises the steps: arranging a first electrical conductor, arranging a second electrical conductor forming a gap to the first electrical conductor, arranging a third electrical conductor, actuating operation of the third electrical conductor to bridge the gap and contact the first and second electrical conductors and close the circuit, wherein the third electrical conductor consisting at least partially of a porous material is used and/or at least one of the first and/or the second electrical conductor consisting at least partially of a porous material are used, and in the course of the actuating operation of the third electrical conductor the latter is compacted at least in the region of contacting with the first and/or second electrical conductor or the first and/or second electrical conductor is or are compacted at least in the area of contact with the third electrical conductor, wherein a material is used as the porous material which has a density of at least 80% of the theoretical density of the material.

Due to the minimum density of 80% of the theoretical density, the safety switch not only displaces material or partially closes pores by compression when closing the electrical contact between the conductors, but also a strain hardening of the third conductor at least in the contact area with the other two electrical conductors is achieved. On the one hand, this improves the connection between the first, second and third electrical conductors. In addition, due to the higher compaction, the contact surfaces between the electrical conductors, and thus also the ability to conduct electrical current, are significantly improved.

According to one embodiment, it may be provided that the porous material has a density of at most 98% of the theoretical density of the material. It can thus be achieved that due to the remaining compactability of the third electrical conductor, the property of preventing material shearing or burr formation is maintained in any case, even if the third electrical conductor already has a very high density. Through the latter, the ability of the third electrical conductor to conduct electrical current may be further improved, wherein values may be achieved that come very close to those of electrical conductors produced by casting.

According to a further embodiment, it may be provided that the porous material from which the third electrical conductor is made or (at least partially) comprises is selected from a group consisting of copper, aluminum, sintered steel, silver, gold, platinum, and alloys of these metals. These materials have a relatively high ductility, which means that a correspondingly good flow behavior can be achieved, which is particularly advantageous in compaction during contact manufacture due to the improved adaptability.

Preferably, according to a further embodiment, the third electrical conductor is a powder-metallurgically produced component or a component produced by means of an additive method, as this makes it easier to set the desired, relatively low porosity.

According to a further embodiment, the actuator may be a pyrotechnic actuator, as this allows the third electrical conductor to be compressed to at least approximately maximum density, at least in the area of electrical contact with the first and second electrical conductors, whereby the corresponding, aforementioned properties of the third electrical conductor can be further improved.

According to a further embodiment, it may be provided that the third electrical conductor has at least one first recess for at least a part of the first electrical conductor and/or at least one second recess for at least a part of the second electrical conductor, whereby the contacting can be improved or the unintentional disconnection of the circuit closed with the third electrical conductor can be better prevented or avoided.

It is advantageous if, according to a further embodiment, the first recess has a width that is smaller than a width of the first electrical conductor and/or that the second recess has a width that is smaller than a width of the second electrical conductor. Due to the smaller width of the recesses, it can be achieved that the compaction of the third electrical conductor during the establishment of the electrical contact with the other two electrical conductors takes place smoothly by “forcing” these electrical conductors into the recesses. This makes it easier to compact the material of the third electrical conductor to (at least near) theoretical density in this range, especially if a pyrotechnic actuator is used.

According to a further embodiment, the third electrical conductor may comprise a plurality of different materials, the porous material being disposed in the region of contactability with the first and second electrical conductors. It is thus possible, for example, to arrange a (metallic) solid material, i.e., a material with the full density, e.g., a cast material, in the area of the arrangement of the pyrotechnic actuator, which can then act on the porous area or section of the third electrical conductor like a hammer. In addition, it can be avoided that the energy of the actuator is partly used up already in the area of the arrangement of the actuator for the compression. It is thus possible to reduce the amount of pyrotechnic material in the safety switch.

### BRIEF DESCRIPTION OF THE DRAWINGS

For the purpose of better understanding of the invention, this will be elucidated in more detail by means of the figures below.

These show respectively in a simplified schematic representation:

FIG. 1 a motor vehicle in side view;

FIG. 2 a first embodiment of a safety switch;

FIG. 3 a further embodiment of a safety switch;

FIG. 4 a section of the safety switch according to FIG. 3 in plan view; and

FIG. 5 an embodiment of a third electrical conductor.

### DETAILED DESCRIPTION

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

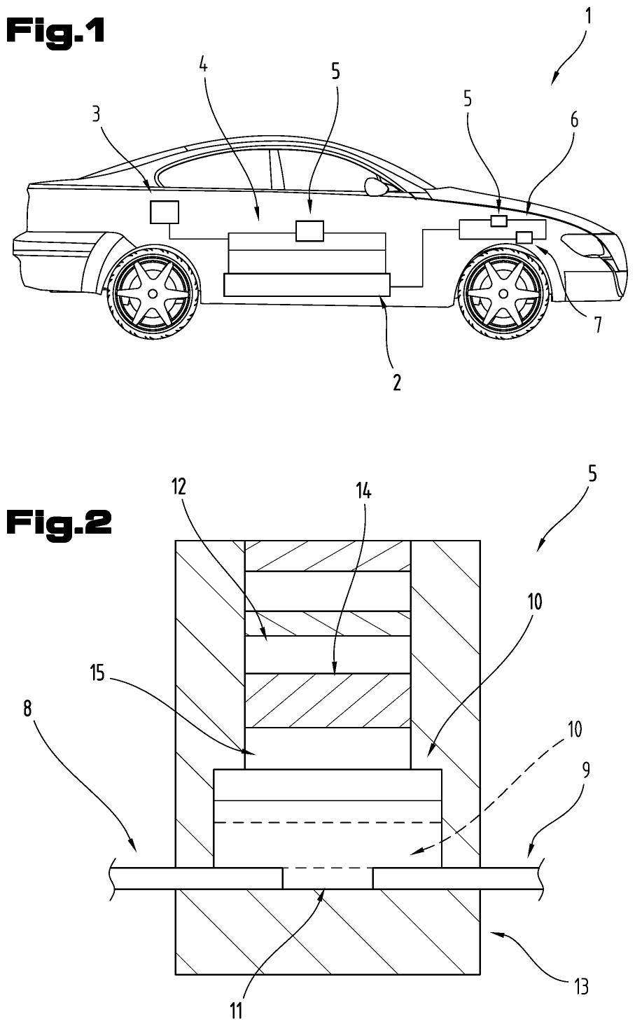

In FIG. 1, a motor vehicle 1 is schematically depicted. The motor vehicle 1 has at least one rechargeable storage element 2 for electric current, in particular an accumulator. Alternatively or additionally, the motor vehicle 1 may have at least one electrical energy generating element 3, in particular a fuel cell. The storage element 2 and/or the electrical energy generating element 3 are integrated in an electrical circuit 4. A safety switch 5 is electrically connected to this circuit 4.

The motor vehicle 1 may also have at least one further electrical circuit 6 in which an energy storage element, in particular a capacitor 7, is arranged. A safety switch 5 may also be electrically connected to this further electrical circuit 6.

The illustration of the motor vehicle 1 in FIG. 1 serves only to clarify the invention. Therefore, the circuits 4, 6 shown are not in themselves to be understood as limiting the invention. Their exact architecture depends on the relevant configuration of the motor vehicle 1. Furthermore, the motor vehicle 1, which is in particular an electric vehicle or a hybrid vehicle, is provided with other components, such as a motor, etc. For further details of these components, reference is made to the relevant state of the art.

Since the above-mentioned safety switches 5 of the motor vehicle 1 may have the same configuration, only one safety switch 5 is described in more detail below.

The safety switch 5 is a so-called make contact and is configured to close at least one circuit for discharging electrical energy as required. The safety switch 5 is further configured to be actuated once in an emergency, such as an accident. Multiple switching between the two positions “circuit open” and “circuit closed” is therefore normally not intended.

FIG. 2 shows a first embodiment of the safety switch. The safety switch comprises a first electrical conductor 8, a second electrical conductor 9 and a third electrical conductor 10. FIG. 2 shows the rest position of the third electrical conductor 10 in which the respective circuit 4, 6 (see FIG. 1) is interrupted with solid lines. For this purpose, the first electrical conductor 8 and the second electrical conductor 9 are arranged at a distance from each other so that a gap 11 is formed between them. Further, the third electrical conductor 10 is arranged at a distance from the first and second electrical conductors 8, 9. In the embodiment shown, the third electrical conductor 10 is arranged above the other two electrical conductors 8, 9. However, the spatial arrangement of the electrical conductors 8-10 can also be different.

The closed position, in which the circuit 4, 6 is closed, is also shown in stroke-dotted lines in FIG. 1. This is achieved by adjusting the third electrical conductor 10 so that the third electrical conductor 10 makes electrical contact with the first electrical conductor 8 and the second electrical conductor 9, thereby bridging the gap 11.

For adjusting the third electrical conductor 10 from the rest position to the position bridging the gap 11, an actuator 12 is provided which acts on the third electrical conductor 10 when required.

Preferably, the first electrical conductor 8 and the second electrical conductor 9 and the actuator 12 are arranged at least partially and the third electrical conductor 10 is arranged entirely in a housing 13, although a different arrangement is possible. The first electrical conductor 8 and/or the second electrical conductor 9 may also be led out of the housing 13, for example, to form contacting points for electrical contacting with the respective electrical circuit 4, 6 with end sections arranged outside the housing 13.

It is provided that at least one of the first, second and third electrical conductors 8-10 is formed of a porous material. The respective other electrical conductor(s) 8-10 is/are formed from a non-porous material, for example a material for casting. Preferably, the first electrical conductor 8 and the second electrical conductor 9 are formed from a porous material, in particular the same porous material, and the third electrical conductor 10 is formed from a non-porous material, in particular a material for casting. Most preferably, the first electrical conductor 8 and the second electrical conductor 9 are formed from a non-porous material, in particular a cast material, and the third electrical conductor 10 is formed from a porous material.

Regardless of which one of the electrical conductors 8-10 consists at least partially of the porous material, the porous material has a density of at least 80%, in particular at least 85%, preferably at least 90%, of the theoretical density, i.e., the full density, of the material.

The theoretical density (full density) is the density that the material has when it has been produced by a casting process.

The actual density of the material is measured as Archimedes' density according to Archimedes' principle, using water at a temperature of 20° C. as liquid.

Preferably, according to one embodiment, the porous material has a density of at most 98% of the theoretical density.

The non-porous material may be a material commonly used for electrical conductors, such as a metal, e.g., copper or aluminum, or a metallic alloy. Since the shaping processes for electrical conductors made of these materials are known, reference is made to the relevant prior art for details.

The porous material is preferably a metal or metallic material. In particular, the porous material according to one embodiment of the safety switch 5 is selected from a group comprising or consisting of copper, aluminum, sintered steel, e.g., stainless steel, silver, gold, platinum, and alloys of these metals. The porous material copper is particularly preferred.

In the following, embodiments of the third electrical conductor 10 made of/with the porous material are described. These embodiments may also be applied to the first and/or second electrical conductors 8, 9 if they are at least partially formed from the porous material.

In principle, the third electrical conductor 10 can be manufactured using different methods. Preferably, however, according to one embodiment of the safety switch 5, the third electrical conductor 10 is manufactured by means of a powder-metallurgical method or by means of an additive method.

Powder-metallurgical methods as such are known, so that further explanations are unnecessary, especially with regard to the temperatures and pressures to be applied. It should only be mentioned that these methods include the steps of powder pressing and sintering. Sintering may be carried out in several stages. Unlike known processes, the third electrical conductor 10 is preferably not calibrated or recompacted after sintering, so that sintering is the last step of the method for manufacturing the third electrical conductor 10. However, it could be provided that the third electrical conductor 10 is sintered to a density of less than 80% of the theoretical density, and that after sintering the third electrical conductor 10 is recompacted to the density of at least 80% of the theoretical density, but taking care that the third electrical conductor 10 must still be porous, preferably having a density of at most 98% of the theoretical density.

Additive methods as such are also known from the prior art. In this method, a three-dimensional component is built up layer by layer from at least one material. The process is computer-controlled using CAD data. The desired porosity is already taken into account in the data stored in a data memory for manufacturing the third electrical conductor 10.

In principle, different actuators 13 can be used in the safety switch 5, for example pneumatic or hydraulic ones. Due to the speed of the adjustment and the pressure that can be built up in the process, a pyrotechnic actuator 12 is used according to a preferred embodiment of the safety switch 5. Such actuators are already used in the automotive industry, for example in airbags or in seatbelt pretensioners.

In the safety switch 5, a propellant 14 of the actuator 12 is utilized to move the third electrical conductor 10 from its rest position to the position bridging the gap 11. Essentially, the pressure acting on the third electrical conductor 10, which is built up in a chamber above the third electrical conductor 10 due to the ignition of the propellant, is used for this purpose. If the actuator 12 is arranged adjacent to the third electrical conductor 10, the actuator 12 acts directly on the third electrical conductor 10 in the initial phase. The chamber 15 is formed only with the adjustment of the third electrical conductor 10 towards the other two electrical conductors 8, 9.

This principle of adjusting the third electrical conductor 10 as such is known, for example from AT 521539 A1 mentioned at the beginning, so that reference is made to the relevant prior art for further details on this or the propellants that can be used. The use of a pyrotechnic actuator 12 has advantages with regard to the already relatively high density of the at least partially porous third electrical conductor 10 compared to other actuators, for example with regard to the deformation work when closing the circuit by contacting the first and second electrical conductors 8, 9 through the third electrical conductor 10.

In principle, the reverse arrangement is also possible, in which the first and second electrical conductors 8, 9 are moved towards the third electrical conductor 10 to close the circuit, in particular by pyrotechnic tripping. However, the embodiment described above with the adjustment of the third electrical conductor 10 is the preferred embodiment.

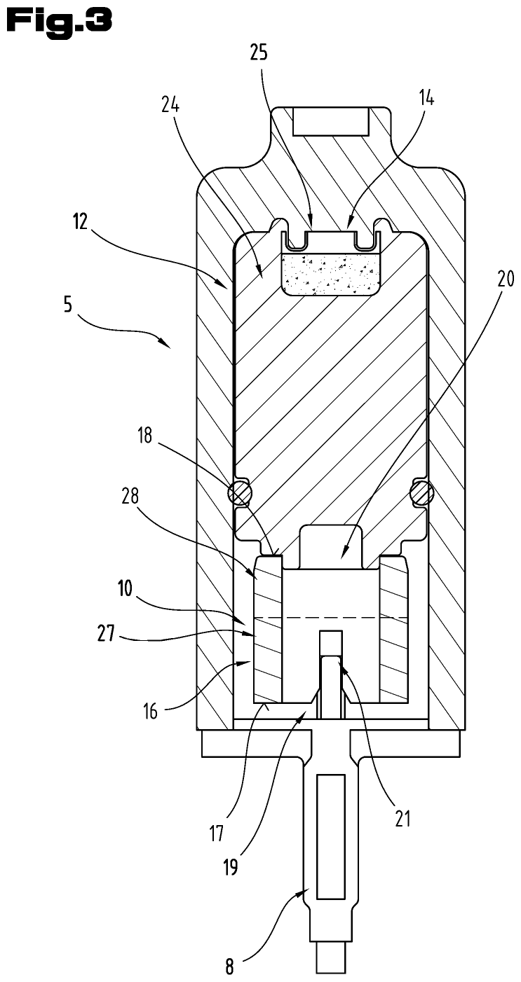

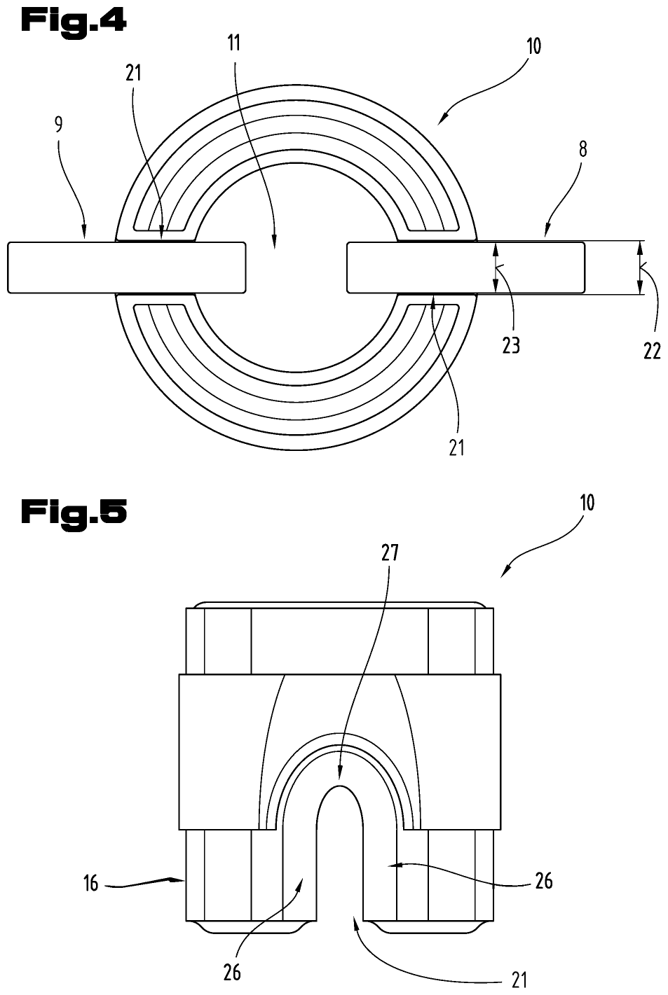

FIGS. 3 and 4 show a further and possibly independent embodiment of the safety switch 5, again using the same reference signs or component designations for the same parts as in FIGS. 1 and 2. In order to avoid unnecessary repetition, reference is made to the detailed description for FIGS. 1 and 2.

As can be seen from FIG. 3, the safety switch 5 is provided with the first electrical conductor 8 and the third electrical conductor 10. The second electrical conductor 9 is shown in FIG. 4. In the illustration of FIG. 3, the second electrical conductor 9 is covered by the first electrical conductor 8.

In principle, the first and second electrical conductors 8, 9 may have any suitable shape. Preferably, however, they are configured as flat sections or flat wires.

In the embodiment of the safety switch 5 according to FIG. 2, the third electrical conductor 10 is also designed as a flat section or flat wire. In the embodiment of FIGS. 3 and 4, however, the third electrical conductor 10 has a sleeve-like shape. The third electrical conductor 10 is provided with a jacket 16 which is bounded in the axial direction by a first front face 17 and a second front face opposite the first front face. The first front face 17 is adjacent to or defines a first opening 19. The second front face 18 is adjacent to or defines a second opening 20.

The first and second front faces 17, 18 are preferably formed as circular ring faces or circular ring sections (interrupted circular rings). However, the shape of the first and/or second front faces 17, 18 may also be different, for example as a rectangular ring face or square ring face or generally polygonal ring face, or oval ring face, etc. It is meant that the first and second front faces 17, 18 are formed as an annular surface with, for example, a square inner and outer circumference. Generally, the inner and outer circumferences of the first and second front faces 17, 18 have the same geometric shape, for example, they are both circular or rectangular or square, etc.

The third electrical conductor 10, which is shown in the rest position in FIG. 3, is provided with two recesses 21. In particular, these are formed as (slit-shaped) openings through the third electrical conductor 10. However, they may also only be groove-shaped recesses.

The two recesses 21 are arranged opposite each other in the jacket 16 of the third electrical conductor 10. If the two other electrical conductors 8, 9 are not arranged in one plane, the recesses 21 may also be arranged at another location on the circumference of the jacket 16 of the third electrical conductor 10.

Several of these recesses 21 may also be arranged in the jacket 10.

The recesses 21 serve to receive the first and second electrical conductors 10 for closing the circuit 4, 6. The recesses 21, starting in the first front face 17, extend in the axial direction of the third electrical conductor 10 towards the second axial front face 18 and end at a distance therefrom. As the third electrical conductor 10 moves towards the first and second electrical conductors 8, 9, these are received in the recesses 21, so that the third electrical conductor 10 is thus pushed onto the first and second electrical conductors 8, 9.

In the position of the third electrical conductor 10 bridging the gap 11, the first and second electrical conductors 8, 9 are at least partially arranged in the recesses 21, as can be seen in FIG. 4.

A width 22 of the recesses 21 is preferably not greater than a width 23 (i.e., thickness) of the first or second electrical conductors 8, 9 in the region of the receptacle in the respective recess 21. This achieves a correspondingly good contact of the electrical conductors 8 to 10. Any deviations in the shape of the electrical conductors 8 to 10 can be compensated for by the compactability of the third electrical conductor 10.

In the preferred embodiment of the safety switch 5, however, it is provided that the width 22 of the recesses 21 is smaller than the width 23 of the first and second electrical conductors 8, 9, respectively, so that the third electrical conductor 10 is compacted during the formation of the electrical contact with the first and second electrical conductors 8, 9 at least in the region adjacent to the recesses 21, preferably to at least approximately 100% of the theoretical density.

The width 22 of the recesses 21 may be smaller, for example, by at least 5%, in particular at least 6%, preferably at least 8%, and at most 25%, in particular at most 22%, preferably at most 20%, than the width 23 of the first or second electrical conductors 8, 9, in each case viewed in the same direction. For example, the width 22 of the recesses 21 may be 0.3 mm to 0.6 mm smaller than the width 23 of the first or second electrical conductor 8, 9.

The embodiment of the safety switch 5 according to FIGS. 3 and 4 is also preferably provided with a pyrotechnic actuator 12. Unlike the embodiment described above according to FIG. 2, however, the propellant 14 is not arranged directly on the third electrical conductor 10, but a piston 24 is arranged between the propellant 14 and the third electrical conductor 10. This abuts the second front face 18 of the jacket 16 of the third electrical conductor 10 or engages the second aperture 20 of the third electrical conductor 10. The propellant 14 may be disposed in a recess 25 of the piston 24.

The piston 24 may be formed from a solid (metallic) material, i.e., a non-porous material.

FIG. 5 shows an embodiment of the third electrical conductor 10. In this embodiment, transition surfaces 26 from the jacket 16 into the recesses 21 are not sharp-edged, but bevelled or rounded, in order to simplify sliding of the third electrical conductor 10 onto the first and second electrical conductors 8, 9.

In addition, the recesses 21 may also have a cross-sectional shape that deviates from the rectangular shape, for example, they can also be rounded in the area of a base 27 of the recess 21. This embodiment enables easier demolding of the third electrical conductor 10 in the green compact state when it is produced using a powder-metallurgical method.

According to a further embodiment of the safety switch 5, which is indicated by stroke-dotted lines in FIG. 3, it may be provided that the third electrical conductor 10 consists of several (at least two) different (metallic) materials. It is provided that the porous material is arranged in a first portion 27 in which the electrical contact with the first and second electrical conductors 8, 9 is formed. Accordingly, the at least one further material, which may also be a solid material, i.e., a non-porous material, is arranged in a different section, in particular a second section 28 directly adjacent to the first section 27.

The safety switch 5 may be used to close a circuit in case of emergency/need. For this purpose, the first electrical conductor 8 and the second electrical conductor 9 are arranged forming the gap 11 in the safety switch 5, in particular in the housing 13. Further, the third electrical conductor 10 is spaced from the first and second electrical conductors 8, 9 and is actuated in an emergency/need to bridge the gap 11 and thus cause the first and second electrical conductors 8, 9 to make contact and close the circuit. An electrical conductor made of or with a porous material is used as the third electrical conductor 10, and in the course of the actuating operation of the third electrical conductor 10, the latter is compacted at least in the region of contact with the first and/or second electrical conductor 8, 9. The porous material has a density of at least 80% of the theoretical density of the material.

In the preferred embodiment, a sintered body with deliberately lower density is produced as the third electrical conductor 10. The preferred material is copper with a purity of 99.9%. The final density of the third electrical conductor 10 may be between 7.5 g/cm³ and 8.8 g/cm³. In comparison, copper has a full density of 8.96 g/cm³.

Preferably, a pyrotechnic actuator 12 is used with a propellant 14 that builds up a pressure between 40 bar and 90 bar when ignited, so that the third electrical conductor 10 is forced onto the first electrical conductor 8 and the second electrical conductor 9.

After sintering, the third electrical conductor 10 preferably has a Brinell hardness according to DIN EN ISO 6506-1:2015-02 between 30 and 70 HB 2.5/31.25.

The embodiments show or describe possible implementation variants, wherein combinations of the individual implementation variants are also possible.

Finally, for the sake of order, it should be noted that for a better understanding of the structure of the motor vehicle 1 and the safety switch 5, these are not necessarily shown to scale.

It will be obvious to those having skill in the art that many changes may be made to the details of the above-described embodiments without departing from the underlying principles of the invention. The scope of the present invention should, therefore, be determined only by the following claims.

The invention claimed is:

1. A safety switch comprising: a first electrical conductor, a second electrical conductor, a third electrical conductor and an actuator, wherein a gap is formed between the first conductor and the second electrical conductor, which gap can be bridged in an electrically conductive manner with the third electrical conductor by making contact with the first and second electrical conductors, wherein the third electrical conductor is arranged in a rest position from which the third electrical conductor can be brought by the actuator into the position bridging the gap, and wherein either the third electrical conductor consists at least partially of a porous material and/or at least one of the first and/or the second electrical conductor consists at least partially of a porous material, wherein the porous material has a density of at least 80% of the theoretical density of the material.

2. The safety switch according to claim 1, wherein the porous material has a density of at most 98% of the theoretical density of the material.

3. The safety switch according to claim 1, wherein the porous material is selected from a group consisting of copper, aluminum, sintered steel, silver, gold, platinum, and alloys thereof.

4. The safety switch according to claim 1, wherein the third electrical conductor is a powder-metallurgically produced component or a component produced by means of an additive method.

5. The safety switch according to claim 1, wherein the actuator is a pyrotechnic actuator.

6. The safety switch according to claim 1, wherein the third electrical conductor has at least one first recess for at least a part of the first electrical conductor and/or at least one second recess for at least a part of the second electrical conductor.

7. The safety switch according to claim 6, wherein the first recess has a width which is smaller than a width of the first electrical conductor and/or in that the second recess has a width which is smaller than a width of the second electrical conductor.

8. The safety switch according to claim 1, wherein the third electrical conductor comprises a plurality of different materials, the porous material being disposed in the region of contactability with the first and second electrical conductors.

9. A motor vehicle comprising a rechargeable storage element for electrical energy and/or an electrical energy generating element, as well as at least one safety switch for closing, as required, at least one circuit for discharging electrical energy, wherein the safety switch is formed according to claim 1.

10. A method for closing an electrical circuit comprising the steps of:
arranging a first electrical conductor,
arranging a second electrical conductor forming a gap to the first electrical conductor,
arranging a third electrical conductor, and
actuating operation of the third electrical conductor to bridge the gap and contact the first and second electrical conductors and close the circuit,
wherein an electrical conductor made of or with a porous material is used as the third electrical conductor, and/or at least one of the first and/or the second electrical conductors made of or with a porous material is/are used, and in the course of the actuating operation of the third electrical conductor the latter is compacted at least in the region of contacting with the first and/or second electrical conductor or the first and/or second electrical conductor is/are compacted at least in the region of contacting with the third electrical conductor, and
wherein a material having a density of at least 80% of the theoretical density of the material is used as the porous material.
